(19) United States
(12) Patent Application Publication
(10) Pub. No.: US 2013/0054333 A1
(43) Pub. Date: Feb. 28, 2013

(54) PROVIDING CUSTOMER REWARDS PROGRAMS

(71) Applicants: Erik Stephen Ross, Charlotte, NC (US); Susan S. Thomas, Gastonia, NC (US); Xixi Yin, Phoenix, AZ (US)

(72) Inventors: Erik Stephen Ross, Charlotte, NC (US); Susan S. Thomas, Gastonia, NC (US); Xixi Yin, Phoenix, AZ (US)

(73) Assignee: BANK OF AMERICA CORPORATION, Charlotte, NC (US)

(21) Appl. No.: 13/216,884

(22) Filed: Aug. 24, 2011

(51) Int. Cl. G06Q 30/00

(52) U.S. Cl. 705/14.25

(57) ABSTRACT

Methods, computer readable media, and apparatuses for providing customer rewards programs are presented. According to one or more aspects, it may be determined, based on transaction history information, that a group of accountholders is associated with a common interest. Subsequently, it may be determined that one or more entities provide offerings relevant to the common interest. Thereafter, at least one new rewards program may be automatically created with the one or more entities, and the at least one new rewards program may allow the group of accountholders to earn rewards associated with the common interest. According to one or more additional aspects, it may be determined, for a particular accountholder, based on transaction history information associated with the accountholder, that a first rewards program in which the accountholder is not currently enrolled is more advantageous to the accountholder than a second rewards program in which the customer is currently enrolled.

### TECHNICAL FIELD

One or more aspects of the disclosure generally relate to computing devices, computing systems, and computer software. In particular, one or more aspects of the disclosure generally to computing devices, computing systems, and computer software that may be used by an organization, such as a financial institution, or other entity in providing customer rewards programs.

### BACKGROUND

Increasingly, many different sorts of entities and organizations, such as retailers, restaurants, financial institutions, and others, are providing programs via which customers and/or other entities may earn and/or accrue rewards in the form of redeemable points, gift certificates, cash, airline miles, hotel nights, and other products and services. For example, banks and other financial institutions often provide rewards programs to credit card accountholders via which such accountholders earn rewards points as they spend money on their credit cards. As these programs become more and more popular, it may be desirable to develop and implement more convenient, responsive, dynamic, automatic, and customizable ways of providing customer rewards programs.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to providing customer rewards programs. As used herein, “rewards” may include any products, services, and/or offerings thereof that may be provided to a customer of a business and/or organization, such as a financial institution, in exchange for the customer's purchase and/or use of one or more products and/or services of the business and/or organization. Examples of rewards include redeemable points, gift certificates, cash, airline miles, hotel nights, electronics, consumer goods, and/or any other products and/or services.

According to one or more aspects, it may be determined, based on transaction history information, that a group of accountholders is associated with a common interest. Subsequently, it may be determined that one or more entities provide offerings relevant to the common interest. Thereafter, at least one new rewards program may be automatically created with respect to the one or more entities, and the at least one new rewards program may allow the group of accountholders to earn rewards associated with the common interest.

According to one or more additional aspects, it may be determined, for a particular accountholder, based on transaction history information associated with the accountholder, that a first rewards program in which the accountholder is not currently enrolled is more advantageous to the accountholder than a second rewards program in which the customer is currently enrolled.

### BRIEF DESCRIPTION OF THE DRAWINGS

The present disclosure is illustrated by way of example and not limited in the accompanying figures in which like reference numerals indicate similar elements and in which:

FIG. 1 illustrates an example computing system environment in which various aspects of the disclosure may be implemented.

FIG. 2 illustrates an example system which may implement one or more aspects of the disclosure.

FIGS. 3A and 3B illustrate an example method of dynamically creating, negotiating, and/or providing a customer rewards program according to one or more illustrative aspects of the disclosure.

FIGS. 4A and 4B illustrate an example method of automatically reevaluating an individual customer's rewards program according to one or more illustrative aspects of the disclosure.

FIG. 5 illustrates an example user interface via which at least one rewards program may be offered to one or more customers according to one or more illustrative aspects of the disclosure.

FIG. 6 illustrates an example user interface via which one or more customers may be notified of an automatic enrollment in at least one rewards program according to one or more illustrative aspects of the disclosure.

FIG. 7 illustrates an example user interface via which at least one customer may be notified about the availability of a more advantageous rewards program according to one or more illustrative aspects of the disclosure.

FIG. 8 illustrates an example user interface via which at least one customer may be prompted to edit and/or enter their rewards program preferences and/or interests according to one or more illustrative aspects of the disclosure.

FIG. 9 illustrates an example user interface via which at least one customer may be notified about the availability of a more advantageous and/or relevant rewards program according to one or more illustrative aspects of the disclosure.

FIG. 10 illustrates another example method of dynamically creating, negotiating, and/or providing a customer rewards program according to one or more illustrative aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

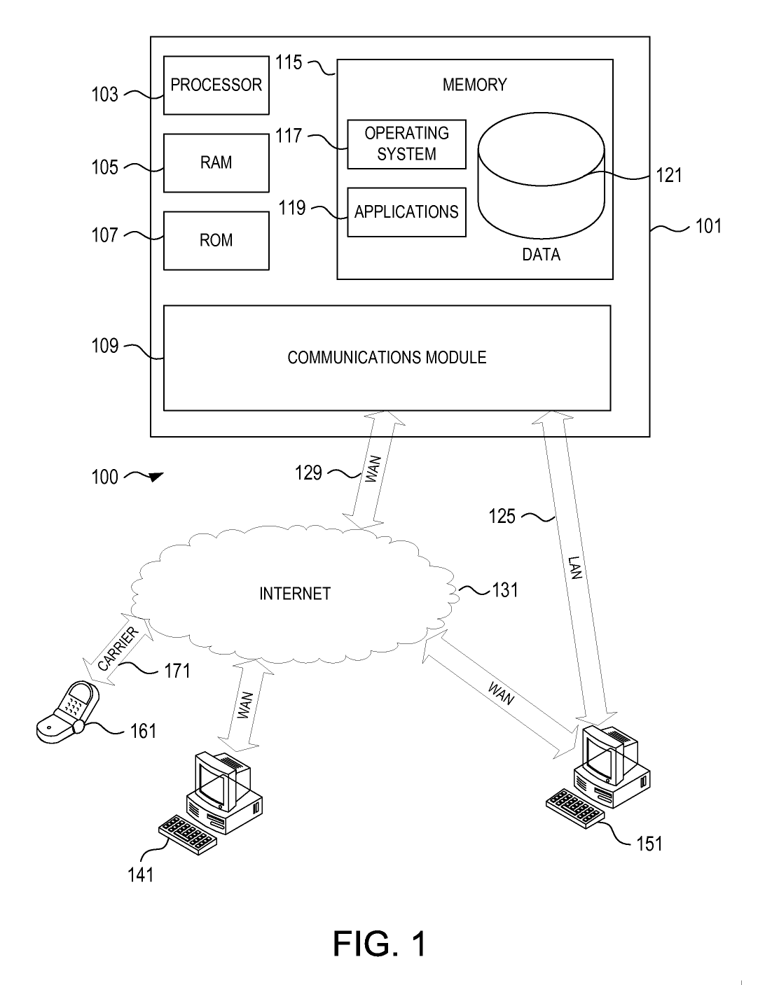

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of computer readable media. Computer readable media may be any available media that may be accessed by computing device 101 and may include both volatile and nonvolatile media, removable and non-removable media. By way of example, and not limitation, computer readable media may comprise a combination of computer storage media and communication media.

Computer storage media may include volatile and nonvolatile, removable and non-removable media implemented in any method or technology for storage of information such as computer readable instructions, data structures, program modules or other data. Computer storage media may include, without limitation, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media may embody computer readable instructions, data structures, program modules or other data in a modulated data signal such as a carrier wave or other transport mechanism and includes any information delivery media. A modulated data signal may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media.

Computing system environment 100 may also include optical scanners (not shown). Exemplary usages of such scanners may include scanning and converting paper documents, e.g., correspondence, receipts, etc. to digital files.

Although not shown, RAM 105 may include one or more are applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual, and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media may include any available media that can be accessed by a computing device 101. Computer-readable media may comprise storage media and communication media and in some examples may be non-transitory. Storage media may include volatile and nonvolatile, removable and non-removable media implemented in any method or technology for storage of information such as computer-readable instructions, object code, data structures, program modules, or other data. Communication media may include any information delivery media and typically may embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. In one or more arrangements, aspects of the method steps disclosed herein may be executed on a processor on a computing device 101. Such a processor may execute computer-executable instructions stored on a computer-readable medium.

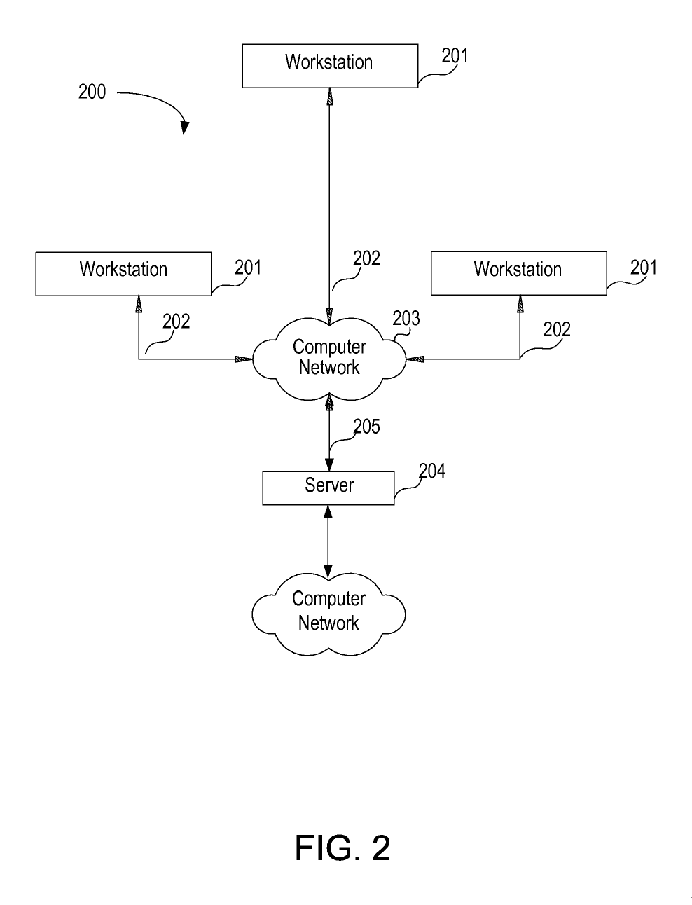

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps described in the following discussion and/or illustrated in the accompanying figures may be implemented by one or more of the components in FIGS. 1 and 2 and/or other components, including other computing devices.

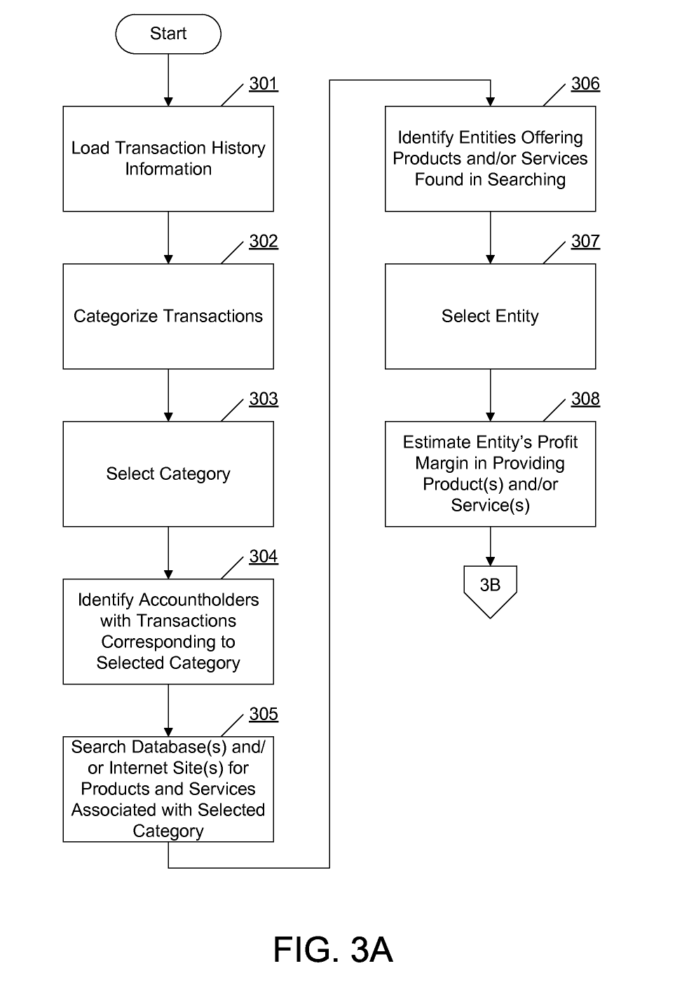

FIGS. 3A and 3B illustrate an example method of dynamically creating, negotiating, and/or providing a customer rewards program according to one or more illustrative aspects of the disclosure. In one or more arrangements, any and/or all of the steps of the example methods described herein may be performed by a computing device (e.g., computing device 101), performed by a plurality of computing devices operating as a computing system (e.g., system 200), and/or embodied as computer-executable instructions stored on a non-transitory computer-readable medium (e.g., a hard disk, a removable disk, memory 115, etc.). The steps also may be rearranged into other orders, additional steps may be added, and/or one or more steps may be removed. Additionally or alternatively, any and/or all of the example user interfaces described herein may be displayed by and/or caused to be displayed by a computing device (e.g., computing device 101) operating alone and/or in combination with a display device (e.g., a video display screen communicatively coupled to computing device 101).

In step 301, transaction history information may be loaded. For example, in step 301, a computing device maintained, operated by, and/or otherwise associated with a financial institution (e.g., computing device 101) may load transaction history information. The transaction history information may be loaded from an account portfolio database maintained by the financial institution, and in at least one arrangement, such transaction history information may include detailed information about a plurality of transactions involving a plurality of accounts serviced by the financial institution. For instance, with respect to each transaction, the account portfolio database may store transaction history information that identifies the payee, the payor, the amount of the transaction, the time and/or date the transaction was completed, and/or other information associated with the transaction (e.g., the location the transaction was completed, the nature of the transaction, such as whether it was an in-store transaction or an online transaction, and/or other information about the particular transaction). In some arrangements, the account portfolio database may be stored on the computing device performing step 301, while in other arrangements, the account portfolio database may be stored on a central enterprise data server and/or data management system, and may be accessed electronically by the computing device performing one or more steps of the example method.

In step 302, one or more transactions may be categorized. For example, in step 302, the computing device may categorize the plurality of transactions described by the transaction history information loaded in step 301. The computing device may categorize the transactions in a variety of different ways, such as by payor (e.g., by customer), by payee (e.g., by the particular payee involved in the transaction, and/or by the type of payee involved in the transaction, such as large retailer, small boutique, grocery store, gas station, fine dining, chain restaurant, café, etc.), and/or by the type of goods and/or services purchased (e.g., groceries, gas, clothing, jewelry, travel, etc.). In some arrangements, the transaction history information loaded from the account portfolio database may already include such categorization information (e.g., because the financial institution and/or another associated computing device, such as a back office computer, may have already categorized the transactions described by the transaction history information). In these arrangements, the computing device performing the example method illustrated in FIGS. 3A and 3B might not perform step 302, as it might not be necessary to re-categorize the transactions. Rather, in these arrangements, the computing device may, in performing the subsequent steps, use the categorization information already included in the transaction history information.

In step 303, at least one category of the plurality of categories may be selected. As further described below, the computing device may dynamically create, negotiate, and/or provide a customer rewards program under which one or more customers may be able to earn rewards in the form of goods and/or services associated with the category selected in step 303. For example, in step 303, the computing device may select a category, such as gourmet coffee, from the plurality of categories of transactions created and/or loaded in step 302. Subsequently, by performing one or more steps described below, the computing device may dynamically create, negotiate, and/or provide a customer rewards program under which one or more customers may be able to earn rewards associated with gourmet coffee, such as discounts and/or gift certificates redeemable for coffee and snacks at particular coffee shops, coffee machines sold by particular companies, and/or other products and services related to gourmet coffee.

In step 304, one or more accountholders who have completed transactions corresponding to the selected category may be identified. For example, in step 304, the computing device may search the transaction history information and create a list that identifies one or more accountholders who completed transactions involving goods and/or services corresponding to the category selected in step 303. Continuing the previous example, for instance, the computing device thus may search the transaction history information to identify customers that have completed transactions associated with gourmet coffee (e.g., transactions purchasing gourmet coffee, transactions purchasing coffee machines, etc.), and the computing device then may create a list of such customers (e.g., by storing the names, account numbers, and/or user identifiers of these customers in memory).

In step 305, one or more databases and/or internet websites may be searched for products and/or services associated with the selected category. For example, in step 305, the computing device may search the internet for products and services associated with the selected category (e.g., gourmet coffee). In performing such a search, the computing device may use a commercially available search engine, such as GOOGLE or YAHOO, to locate websites via which products and services associated with the selected category are sold. Additionally or alternatively, the computing device may search an internal database (e.g., a database maintained by the financial institution) in which a catalog of various goods and services, as well as information about the various entities offering such goods and services, is stored.

In step 306, one or more entities offering the products and/or services found in the searching may be identified. For example, in step 306, the computing device may identify what entities are offering the products and/or services found in the searching based on information included in the databases and/or internet websites that were searched. If, for instance, the computing device searched one or more databases in step 305, then the computing device may identify the entities offering the products and/or services found in the searching by accessing and/or storing provider information from the database(s) searched, where the provider information indicates the entities providing the corresponding goods and/or services. Additionally or alternatively, if the computing device searched one or more internet websites in step 305, then the computing device may identify the entities offering the products and/or services found in the searching by downloading information from the websites that were searched, such as information about who maintains and/or operates the particular website, information posted on the website about who sells, ships, and/or provides the goods and/or services described on the particular website, and/or the like.

In step 307, at least one entity of the one or more identified entities may be selected. As further described below, the entity selected in step 307 may be the entity with respect to which a rewards program may subsequently be negotiated and/or created. Continuing the previous example in which the selected category may be gourmet coffee, the computing device may, for instance, select an entity which was identified in step 306 as offering products and/or services related to gourmet coffee (e.g., gift certificates redeemable for gourmet coffee at particular coffee shops, high-end coffee machines, etc.).

Additionally or alternatively, in step 307, the at least one entity may be selected based on one or more factors, such as the particular entity's status with the financial institution (e.g., whether the particular entity is considered a “preferred provider” of the financial institution), a level of popularity of the particular entity (e.g., how many customers of the financial institution patronize the particular entity, as determined based on historical transaction information), and so on. These additional selection factors may be useful, for example, in instances where two or more entities identified in step 306 offer similar products and/or services, as such factors may provide a basis upon which the entities may be differentiated.

For example, in step 307, the computing device may access a database in which a list of preferred providers is stored and subsequently select an entity identified in step 306 further based on whether the entity is included in the list of preferred providers. In another example, in step 307, the computing device may access transaction history information (e.g., stored in the financial institution's account portfolio database) and generate a popularity rank of the one or more entities identified in step 306 based on how many customers have patronized each entity and/or how many transactions have been completed with respect to each entity. Subsequently, in this example, the computing device may select an entity based on the generated popularity rank (e.g., the computing device may select the entity determined to be the most popular, as based on the generated popularity rank).

In one or more additional arrangements, information from one or more social networks may be used to generate such a popularity rank. For example, in step 307, the computing device may access information from one or more social networks (e.g., FACEBOOK, LINKEDIN, etc.) to determine customer interests (e.g., what groups one or more customers are members of; what charitable organizations one or more customers contribute to; what activities, sports, movies, television shows, music, etc. one or more customers enjoy, etc.). Then, in this example, the computing device may generate and/or reorder a popularity rank of the one or more entities based on how well each of the one or more entities matches up with the customer interests determined based on the social networking information. In some instances, one or more customers might need to provide (and the financial institution's computing device may receive) login information and/or other access permission to profiles of the one or more customers on the one or more social networks (e.g., one or more customers might need to “friend” or “follow” the financial institution on a given social network so that the financial institution's computing device may access information about the one or more customers and generate a popularity rank accordingly).

In step 308, the selected entity's profit margin in providing the products and/or services may be estimated. For example, in step 308, the computing device may estimate the selected entity's profit margin by assuming that the entity realizes as profit a particular percentage of the listed price for the product and/or service. In one or more arrangements, different percentages may be used for different types of products and/or services, and information about these percentages (e.g., information indicating which percentages should be used in estimating profit margins with respect to what types of products and/or services) may be stored in the memory of the computing device. For instance, with respect to gourmet coffee gift certificates redeemable at particular coffee shops, the computing device may assume that such coffee shops realize a fifty percent profit in selling gourmet coffee products. Thus, in an example where the computing device selected a $20 gift certificate offered by such coffee shops as the product with respect to which a new rewards program is to be negotiated and/or created, the computing device may determine that fifty percent of the $20 gift certificate, or $10, is realized as profit by the coffee shop for each gift certificate sold. As described below, this profit margin may be used by the computing device in calculating a discounted price and negotiating and/or creating a new rewards program.

In step 309, a discounted price for the particular product(s) offered by the selected entity may be calculated. For example, in step 309, the computing device may calculate a discounted price for the particular products by multiplying the profit margin estimated in step 308 by a particular fraction (e.g., one-half, one-third, etc.) and subtracting this product from the listed price of the particular product(s) offered by the selected entity. Any desirable fraction may be used, and in some arrangements, different fractions may be used with respect to different types of products and/or services and/or with respect to different types of entities (e.g., the computing device may select a lower fraction for entities that are preferred partners of the financial institution, thus allowing such entities to receive a greater profit margin, and/or the computing device may select a greater fraction for entities that are not preferred partners of the financial institution).

In step 310, the entity's total profit amount at the discounted price may be estimated. For example, in step 310, the computing device may estimate the entity's total profit amount at the discounted price by multiplying the entity's estimated profit margin by the fraction used in step 309 to calculate the discounted price, and by multiplying the product of this calculation by the total number of accountholders identified in step 304. The computing device subsequently may treat the result of this calculation as the entity's estimated total profit amount.

In step 311, the discounted price and/or the entity's estimated total profit amount may be transmitted to the entity. For example, in step 311, the computing device may transmit (e.g., electronically via a synchronous or asynchronous data connection, via an email or other electronic message, etc.) the discounted price and/or the entity's estimated total profit amount, as determined in the foregoing steps, to the previously selected entity. In one or more arrangements, this message may function as an offer (e.g., by the financial institution) that asks the entity to agree to providing the particular products and/or services at the discounted price so that such products and/or services may be offered as rewards under a new customer rewards program. Additionally or alternatively, it may be desirable to include both the discounted price and the entity's estimated total profit amount in the message, as this information may enable the entity to evaluate the offer and determine whether it would like to facilitate the proposed rewards program.

In step 312, it may be determined whether the entity has agreed to provide the particular products and/or services at the discounted price. For example, in step 312, the computing device may determine whether an acceptance message has been received from the entity (e.g., indicating that the entity has agreed to provide the particular products and/or services at the discounted price so that such products and/or services may be offered as rewards under a new customer rewards program). If it is determined, in step 312, that an acceptance message has not been received from the entity (e.g., because a rejection message has been received, because a predetermined amount of time has elapsed without any response being received, etc.), then the method may return to step 309 in which a new discounted price may be calculated (e.g., a smaller discount may be calculated, such that the entity may realize a larger per-unit revenue on products and/or services provided via the proposed rewards program). Subsequently, steps 310-312 may be repeated to determine whether the entity is willing to accept the new offer.

Alternatively, if it is determined, in step 312, that an acceptance message has been received from the entity, then in step 313, rewards program information may be stored in a database. For example, in step 313, the computing device may store information about the rewards program (e.g., as newly created by the entity accepting the offer to provide the particular goods and/or services at the discounted price) so as to enable the rewards program to be offered and/or provided to various customers. In one or more arrangements, this information may include the terms of the rewards program (e.g., what types of purchases accrue rewards, how many rewards are accrued for different types of purchases, what kinds of rewards are accrued, etc.), the type of products and/or services that may be earned under the rewards program (e.g., airline miles, hotel nights, cash back, gift certificates, etc.), and/or any other desired information.

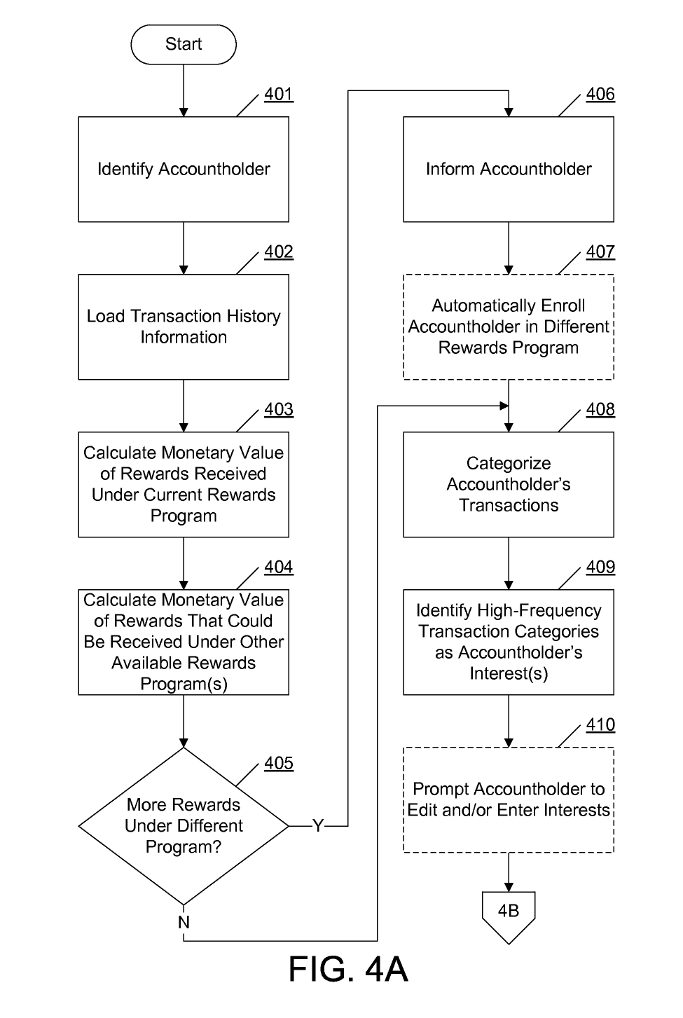

In step 314, the rewards program (e.g., the rewards program defined by the rewards program information stored in step 313) may be offered to the identified accountholders (e.g., the accountholders identified in step 304 as having completed transactions corresponding to the selected category). For example, in step 314, the computing device may offer the rewards program to one or more of the identified accountholders by displaying a user interface to one or more of such accountholders that includes information about the rewards program. In some arrangements, the computing device may send an electronic mail message to one or more of the identified accountholders to inform them about the new rewards program. An example of such a message is illustrated in the example user interface illustrated in FIG. 5. In particular, FIG. 5 illustrates an example user interface via which at least one rewards program may be offered to one or more customers according to one or more illustrative aspects of the disclosure. As seen in FIG. 5, such a user interface may include information about the new rewards program, such as its terms and the types of rewards that may be earned, as well as information about how an accountholder may enroll in the rewards program (e.g., via a hyperlink, via a website, etc.).

Referring again to FIG. 3B, in optional step 315, one or more of the identified accountholders may be automatically enrolled in the rewards program. For example, in optional step 315, the computing device may automatically enroll one or more of the previously identified accountholders in the newly created rewards program based on user preference settings associated with the one or more accountholders to be automatically enrolled. For instance, such accountholder(s) may have previously specified in their user preference settings that they consent to and/or would prefer to be automatically enrolled in new rewards programs that match their spending habits. In some arrangements, accountholders may, by default, be automatically enrolled in new rewards programs that match their spending habits, unless they expressly opt-out of such automatic enrollment in advance. In one or more arrangements, accountholder interests may be determined using information retrieved from one or more social networks, and accountholders may be automatically enrolled in new rewards programs based on such information.

For example, in step 315, the computing device may access information from one or more social networks (and/or access information previously retrieved from one or more social networks), such as the user profiles of one or more accountholders of the financial institution. Such user profiles may include information regarding the interests of one or more accountholders (e.g., what groups one or more accountholders are members of; what charitable organizations one or more accountholders contribute to; what activities, sports, movies, television shows, music, etc. one or more accountholders enjoy; etc.). Subsequently, the computing device may automatically enroll one or more of the previously identified accountholders in the rewards program based upon the information included in these user profiles (e.g., the computing device may select accountholders to enroll in a particular rewards program, or vice versa, based on one or more of the accountholders having interests, as indicated by the user profiles, that match a predetermined number of characteristics of the rewards program, such as the type and quantity of rewards that may be earned under the rewards program).

For instance, if the rewards program created in previous steps provides rewards in the form of gift certificates that may be redeemed at wine shops, the computing device may automatically enroll, into this rewards program, accountholders who have indicated an interest in wine and/or fine dining on their corresponding social network pages (e.g., in their FACEBOOK profile). As noted above, in order to access this information in some instances, one or more accountholders might need to provide (and the financial institution's computing device may receive) login information and/or other access permission to profiles of the one or more accountholders on the one or more social networks (e.g., one or more accountholders might need to “friend” or “follow” the financial institution on a given social network so that the financial institution's computing device may access information about the one or more accountholders).

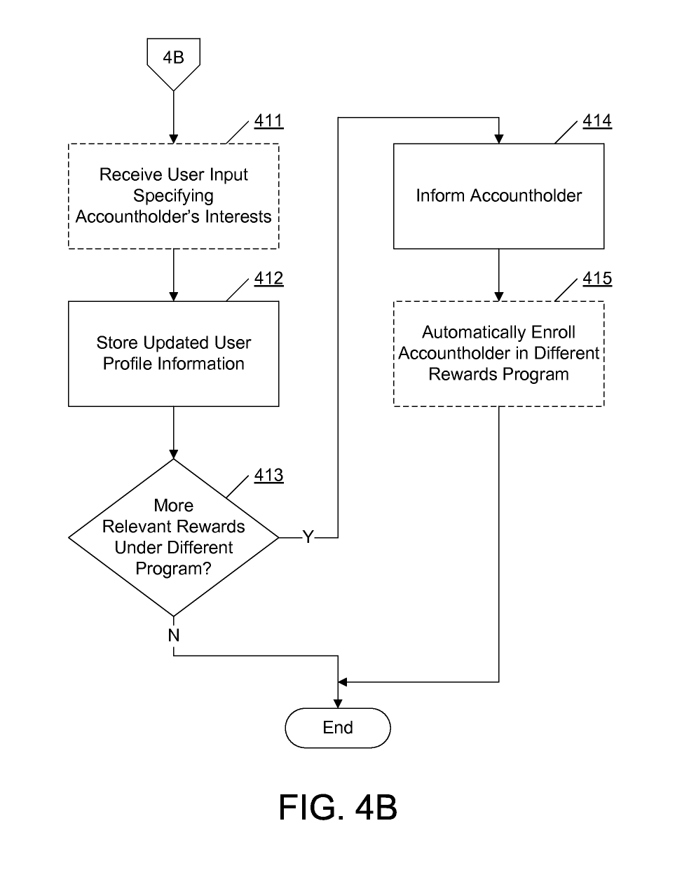

According to one or more aspects, when a user is automatically enrolled in a new rewards program, an electronic mail message and/or other notification may be sent to and/or displayed to the user (e.g., by the computing device, such as computing device 101). An example of such a user interface is illustrated in FIG. 6. In particular, FIG. 6 illustrates an example user interface via which one or more customers may be notified of an automatic enrollment in at least one rewards program according to one or more illustrative aspects of the disclosure. As seen in FIG. 6, such a user interface may include information about the new rewards program such as its terms and the types of rewards that may be earned, as well as information about how an accountholder may change their settings and/or enroll in a different rewards program (e.g., via a hyperlink, via a website, etc.).

Having thus described an example method via which a new rewards program may be dynamically created, a method via which an individual customer's rewards program may be automatically reevaluated will now be described.

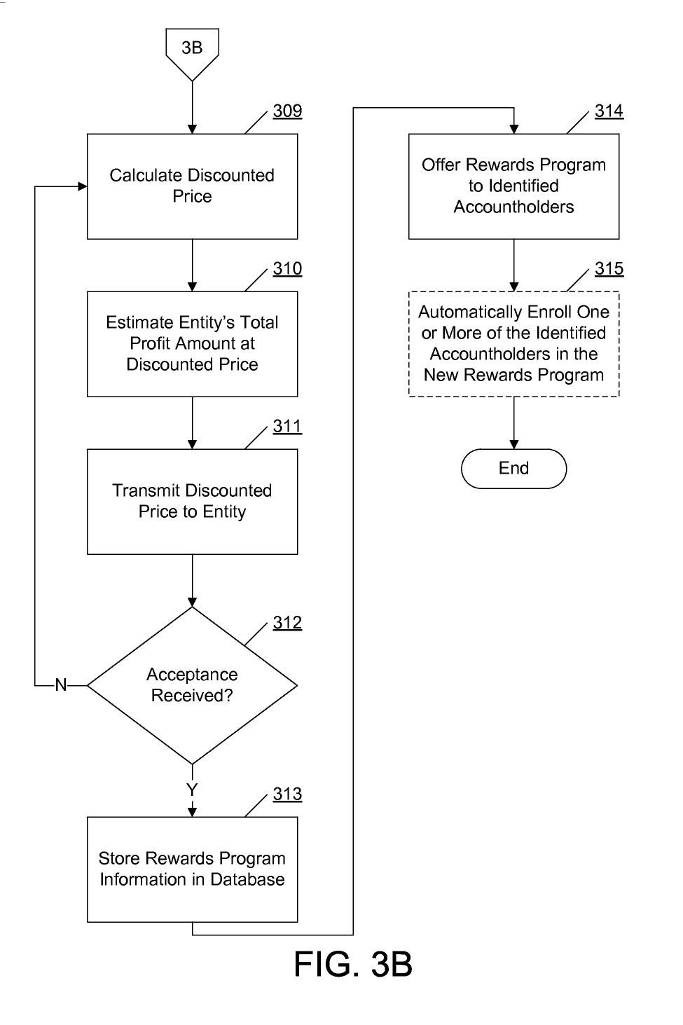

FIGS. 4A and 4B illustrate an example method of automatically reevaluating an individual customer's rewards program according to one or more illustrative aspects of the disclosure. In step 401, an accountholder may be identified. For example, in step 401, a computing device maintained, operated by, and/or otherwise associated with a financial institution (e.g., computing device 101) may identify an accountholder. The accountholder may be a customer of the financial institution, for instance, and the financial institution's computing device may identify the accountholder to enable reevaluation of the accountholder's current rewards program by performing one or more steps of the example method, as further described below.

In step 402, transaction history information may be loaded. For example, in step 402, the computing device may load transaction history information (e.g., from an account portfolio database), similar to how transaction history information may be loaded in step 301, as described above.

In step 403, the monetary value of rewards received by the accountholder under the accountholder's current rewards program may be calculated. For example, in step 403, the computing device may determine (e.g., based on customer records, rewards program records, the transaction history information, etc.) what, if any, rewards the accountholder has earned under the accountholder's current rewards program. Subsequently, the computing device may calculate the monetary value of the rewards earned by the accountholder by multiplying each reward by its corresponding retail price (or other value estimate, e.g., for non-retail items). In one or more arrangements, the computing device may obtain such retail prices and/or value estimates from a database or table maintained, for instance, by the financial institution, while in other arrangements, the computing device may obtain one or more retail prices and/or value estimates from the internet.

In step 404, the monetary value of rewards that the accountholder could receive under one or more other available rewards programs may be calculated. For example, in step 404, the computing device may determine what, if any, rewards the accountholder could have earned under one or more other available rewards programs (e.g., in which the accountholder is not currently enrolled). In some arrangements, this may involve the computing device analyzing the accountholder's transaction history (e.g., based on the transaction history information) and then evaluating, based on the various terms and conditions of different available rewards programs, what rewards the accountholder could have earned under the different available rewards programs. Subsequently, the computing device may calculate the monetary value of the rewards that the accountholder could have earned by multiplying each reward by its corresponding retail price (or other value estimate, e.g., for non-retail items). Here again, the computing device may obtain such retail prices and/or value estimates from a database or table maintained, for instance, by the financial institution. Additionally or alternatively, the computing device may obtain one or more retail prices and/or value estimates from the internet.

In step 405, it may be determined whether the accountholder could receive rewards worth a greater monetary value under one or more other available rewards programs than under the accountholder's current rewards program. For example, in step 405, the computing device may determine whether the accountholder could receive rewards worth a greater monetary value under one or more other available rewards programs than under their current rewards program by determining whether any of the one or more monetary values calculated in step 404 are greater than the monetary value calculated in step 403.

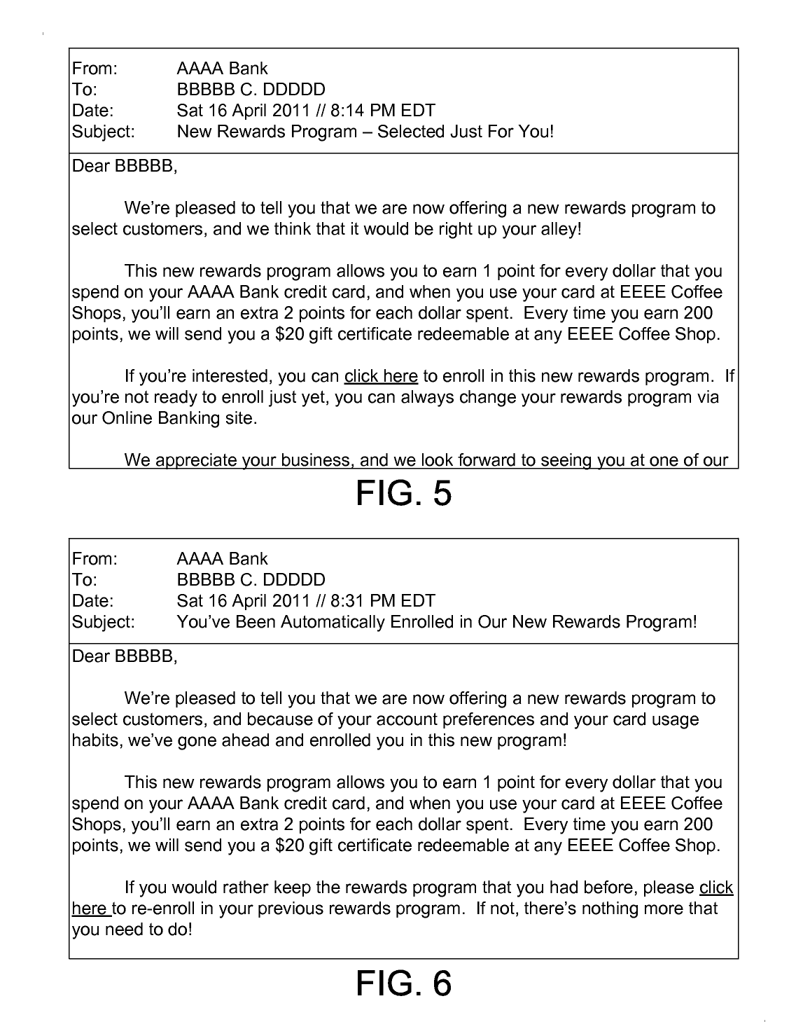

If it is determined, in step 405, that the accountholder could not receive rewards worth a greater monetary value under one or more other available rewards programs, then the method may proceed to step 408, which is further described below. On the other hand, if it is determined, in step 405, that the accountholder could receive rewards worth a greater monetary value under one or more other available rewards programs, then in step 406, the accountholder may be informed of this determination. In one or more arrangements, the accountholder may be informed of such a determination via a user interface displayed on a screen and/or via an electronic message. An example of a user interface that includes such a message is illustrated in FIG. 7. In particular, FIG. 7 illustrates an example user interface via which at least one customer may be notified about the availability of a more advantageous rewards program according to one or more illustrative aspects of the disclosure. As seen in FIG. 7, such a user interface may include information about the rewards program (e.g., terms and conditions of the rewards programs, the types of rewards that could be earned, etc.) under which the user could earn more valuable rewards, as well as information about how an accountholder might enroll in the rewards program (e.g., via a hyperlink, via a website, etc.).

Referring again to FIG. 4A, in optional step 407, the accountholder may be automatically enrolled in a different rewards program, such as one of the rewards programs under which the accountholder could receive rewards worth a greater monetary value, as determined in step 406. For example, in step 407, the computing device may automatically enroll the accountholder in one of the rewards programs under which the accountholder could receive rewards worth a greater monetary value, similar to how the computing device might automatically enroll an accountholder in a rewards program in step 315, as described above. In some arrangements, if there are multiple rewards programs under which the accountholder could receive rewards worth a greater monetary value, then the computing device may enroll the user in the rewards program under which the accountholder could receive rewards worth the greatest monetary value. In other arrangements, if there are multiple rewards programs under which the accountholder could receive rewards worth a greater monetary value, then the computing device may enroll the user in the rewards program under which the accountholder could receive rewards that most match the accountholder's interests (e.g., by performing one or more subsequent steps of this example method, as described below).

In step 408, the accountholder's transactions may be categorized. For example, in step 408, the computing device may categorize the accountholder's transactions (e.g., based on the transaction history information), similar to how the computing device might categorize transactions in step 302, as described above.

In step 409, the categories of transactions that the accountholder has completed at a higher frequency than other categories of transactions may be identified as the accountholder's interests. For example, in step 409, the computing device may analyze the transaction history information in view of the transaction categorization performed in step 408 to determine the frequencies at which various categories of transactions were completed (e.g., how many times per day, how many times per week, how many times per month, etc.). For instance, the computing device may determine that the accountholder completes two “grocery” transactions per week, three “travel” transactions per month, and six “coffee” transactions per week. Subsequently, the computing device then may identify the user's interests based on this frequency information. In some arrangements, the computing device may determine a user's interest in a type of product or service if the frequency of the corresponding category of transactions exceeds a predetermined threshold (e.g., more than three times per week, more than four times per month, etc.). For instance, if an accountholder completes more than five “coffee” transactions per week, then the computing device may determine that the accountholder has an interest in coffee. In other arrangements, the computing device may determine a user's interests in products and/or services by determining that a predetermined number (e.g., two, three, etc.) of the most frequent categories of transactions represent the user's interests. For instance, if the computing device were configured to identify two interests of the accountholder, and if the computing device determined that the accountholder completes two “grocery” transactions per week, three “travel” transactions per month, and six “coffee” transactions per week, then the computing device may determine that the accountholder is interested in groceries and coffee, as these categories represent the accountholder's most frequent transactions.

In some instances, the computing device also may account for the location(s) where such transactions are completed, and the accountholder's interests may incorporate this location component. For instance, the computing device may determine that the customer frequently completes coffee transactions in a particular location, such as in a particular neighborhood or in the vicinity of a grocery store where the customer completes several grocery transactions. This location information may establish a mobility pattern, which may indicate, for instance, that on Saturday mornings, the accountholder typically purchases coffee at a particular coffee shop and then goes grocery shopping at a particular grocery store.

In one or more arrangements, the computing device may determine one or more mobility patterns for an accountholder, and these determined mobility patterns may be used by the computing device in evaluating and/or offering rewards to the accountholder (e.g., in the previous example, the computing device may determine to provide the accountholder with a discount on groceries if the accountholder purchases, on Saturday mornings, coffee at a particular coffee shop, such as a different coffee shop than the one that the accountholder typically visits, prior to going grocery shopping). Additionally or alternatively, the accountholder's interests may be determined, in whole or in part, based on information retrieved for one or more social networking sites, as described above. For instance, the computing device may access and/or retrieve information from the accountholder's user profile on a social networking service (e.g., FACEBOOK, LINKEDIN, etc.), and such information may be indicative of the accountholder's interests.

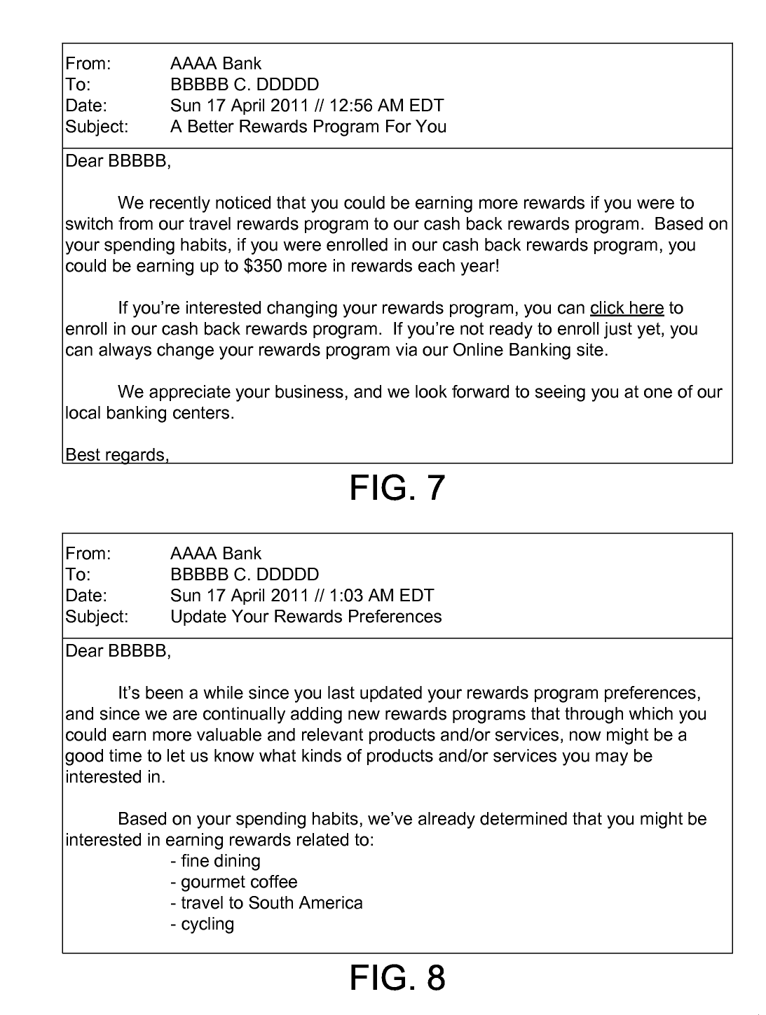

In optional step 410, the accountholder may be prompted to edit and/or enter their interests. For example, in step 410, the computing device may display a user interface prompting and/or enabling an accountholder to provide user input specifying their interests and/or editing the interests determined by the computing device in step 409. An example of such a user interface is illustrated in FIG. 8. In particular, FIG. 8 illustrates an example user interface via which at least one customer may be prompted to edit and/or enter their rewards program preferences and/or interests according to one or more illustrative aspects of the disclosure. As seen in FIG. 8, such a user interface may include a listing of the accountholder's previously specified and/or determined interests, as well as information about how the accountholder may edit such interests and/or enter additional interests (e.g., a hyperlink to a website where a user can edit a form to provide such user input).

Referring now to FIG. 4B, in optional step 411, user input specifying the accountholder's interests may be received. For example, in step 411, the computing device may receive user input via a user interface, such as the one or more user interfaces displayed in step 410.

In step 412, updated user profile information may be stored. For example, in step 412, the computing device may store information about the interests identified in step 409, as well as the interests edited and/or entered in steps 410 and 411, in a profile associated with the accountholder. This profile may be a data table, for instance, stored in a database and/or in the memory of the computing device.

In step 413, it may be determined whether the accountholder could earn more relevant rewards under a different rewards program than the rewards program in which the accountholder is currently enrolled. For example, in step 413, the computing device may compare the rewards the accountholder has earned under their current rewards program with the rewards the accountholder could have earned under one or more other available rewards programs, and then determine, with respect to each rewards program being compared, the number of rewards the accountholder has and/or could receive under the rewards program that match one or more of the accountholder's interests.

If it is determined, in step 413, that the accountholder could not earn more relevant rewards under a different rewards program, then the method may end. For example, if the computing device determines, in step 413, that the accountholder has earned more rewards matching the accountholder's interests under their current rewards program than the accountholder could earn under the one or more other available rewards programs, then the method may end.

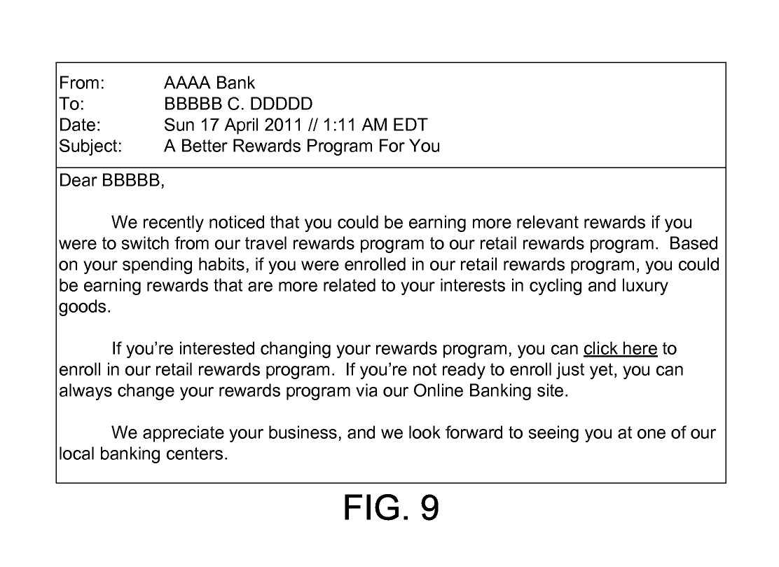

Alternatively, if it is determined, in step 413, that the accountholder could earn more relevant rewards under a different rewards program, then in step 414, the accountholder may be informed of this determination. For example, if the computing device determines, in step 413, that the accountholder could earn a greater number of rewards matching the accountholder's interests under one or more of the other available rewards programs (instead of under their current rewards program), then in step 414, the computing device may display a user interface that informs the user of the determination that the user could be earning more rewards under another program. An example of such a user interface is illustrated in FIG. 9. In particular, FIG. 9 illustrates an example user interface via which at least one customer may be notified about the availability of a more advantageous and/or relevant rewards program according to one or more illustrative aspects of the disclosure. As seen in FIG. 9, such a user interface may include information about the one or more other more advantageous and/or relevant rewards program, such as its terms and the types of rewards that may be earned, as well as information about how an accountholder may enroll in the rewards program (e.g., via a hyperlink, via a website, etc.).

In optional step 415, the accountholder may be automatically enrolled in a different rewards program, such as one of the rewards programs under which the accountholder could earn more relevant rewards, as determined in step 413. For example, in step 415, the computing device may automatically enroll the accountholder in one of the rewards programs under which the accountholder could receive more relevant rewards (e.g., rewards that better match the accountholder's interests), similar to how the computing device might automatically enroll an accountholder in a rewards program in step 315 and/or step 407, as described above. In at least one arrangement, if there are multiple rewards programs under which the accountholder could receive more relevant rewards (e.g., rewards that better match the accountholder's interests), then the computing device may enroll the user in the rewards program under which the accountholder could receive the greatest number of rewards that most closely match the accountholder's interests.

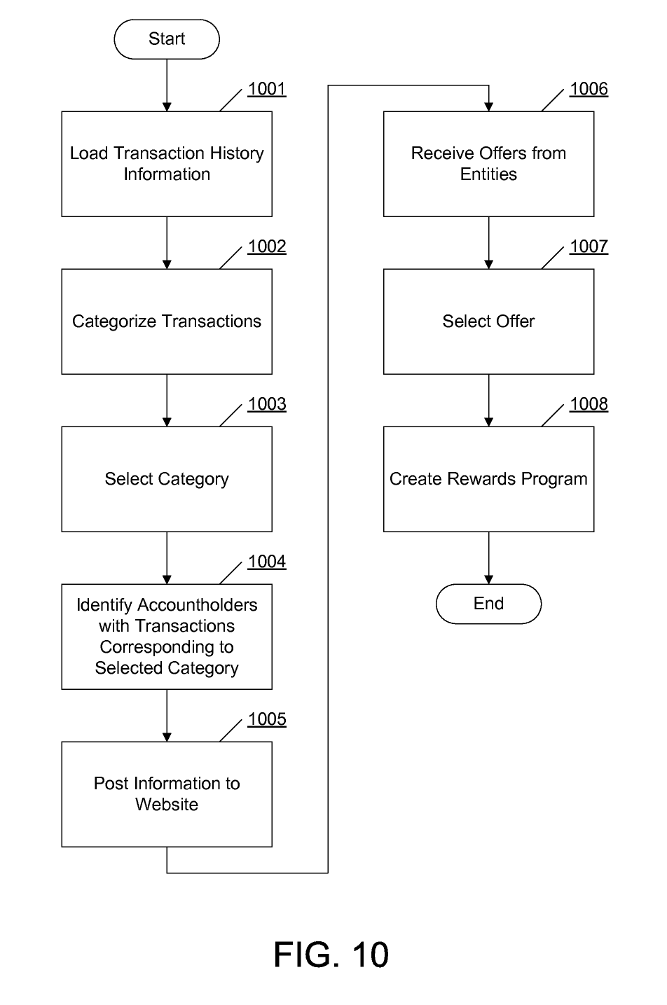

FIG. 10 illustrates another example method of dynamically creating, negotiating, and/or providing a customer rewards program according to one or more illustrative aspects of the disclosure. In step 1001, transaction history information may be loaded, similar to how transaction history information may be loaded in step 301, as described above.

In step 1002, one or more transactions may be categorized, similar to how one or more transactions may be categorized in step 302, as described above.

In step 1003, at least one category of the plurality of categories may be selected, similar to how at least one category of the plurality of categories may be selected in step 303, as described above.

In step 1004, one or more accountholders who have completed transactions corresponding to the selected category may be identified, similar to how one or more accountholders who have completed transactions corresponding to the selected category may be identified in step 304, as described above.

In step 1005, information about the selected category of transactions and/or the identified accountholders may be posted to at least one website. For example, in step 1005, the computing device may post information to a website operated and/or maintained by the financial institution so as to solicit offers from one or more entities that may provide products and/or services relevant to the selected category. The information that may be posted to the website may include, for instance, the number of accountholders with transactions corresponding to the selected category, the number of accountholders with transactions corresponding to the selected category at one or more particular frequencies (e.g., the number of accountholders with one to five transactions per month in the selected category, the number of accountholders with six to ten transactions per month in the selected category, etc.), and/or the number of transactions corresponding to the selected category that are completed by one or more accountholders within a particular time period (e.g., a particular week, month, year, etc.). In some arrangements, information about other interests of the accountholders, such as information about accountholder interests determined based on transaction history information, information retrieved from one or more social networking services, and/or the like, also may be posted to this website.

In step 1006, one or more offers may be received from one or more entities. For example, in step 1006, the computing device may receive, as electronic messages, for instance, one or more offers from other entities to provide products and/or services associated with the selected category as rewards to one or more of the identified accountholders. Such offers may include proposed terms for new rewards programs, such as prices at which goods and/or services may be offered, minimum quantities of goods and/or services that must be ordered, and/or the like.

In step 1007, a particular offer of the one or more received offers may be selected. For example, in step 1007, the computing device may select an offer from the one or more offers electronically received in step 1006 based on the terms of the offer (e.g., based on whether it provides relevant goods and/or services at a price lower than other offers), based on the relevance of the offer (e.g., based on whether it provides goods and/or services that are more closely related to the selected category than other offers), and/or other information. In some arrangements, the computing device may select an offer based on how well it matches other interests of the one or more accountholders, such as interests of the accountholders determined using transaction history information, information from one or more social networking services, and so on.

In step 1008, a rewards program may be created. For example, in step 1008, the computing device may perform one or more steps to create a rewards program based on the selected offer, such as storing rewards program information in a database, similar to how such information may be stored in step 313, offering the rewards program to one or more accountholders, similar to how a rewards program may be offered in step 314, and/or automatically enrolling one or more accountholders in the rewards program, similar to how one or more accountholders may be automatically enrolled in step 315.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A method, comprising:
determining, by a computing device, based on transaction history information, that a group of accountholders is associated with a common interest;
determining, by the computing device, that one or more entities provide offerings relevant to the common interest; and
automatically creating, by the computing device, at least one new rewards program associated with the one or more entities, the at least one new rewards program allowing the group of accountholders to earn rewards associated with the common interest.

2. The method of claim 1, further comprising:
determining, by the computing device, based on the transaction history information, that a second group of accountholders is associated with a second common interest different from the first common interest;
determining, by the computing device, that a second set of one or more entities provide offerings relevant to the second common interest; and
automatically creating, by the computing device, a second new rewards program associated with the second set of one or more entities, the second new rewards program allowing the second group of accountholders to earn rewards associated with the second common interest.

3. The method of claim 1,
wherein determining that one or more entities provide offerings relevant to the common interest includes identifying a product or service advertised on a website, and
wherein automatically creating at least one new rewards program includes:
determining a proposed discount for the product or service based on a price of the product or service available via the website;
transmitting the proposed discount to a particular one of the entities providing the identified product or service; and
receiving an acceptance from the particular entity.

4. The method of claim 3, wherein determining a proposed discount includes:
estimating a profit margin realized by the particular entity providing the identified product or service;
estimating, based on the number of accountholders included in the group and the estimated profit margin, a total profit amount expected to be realized by the particular entity; and
transmitting the estimated profit margin and the estimated total profit amount to the particular entity providing the identified product or service.

5. The method of claim 1, further comprising:
automatically enrolling, by the computing device, at least one of the accountholders in the at least one new rewards program.

6. The method of claim 1, wherein the at least one new rewards program is automatically created based on an offer received from a particular one of the entities.

7. At least one non-transitory computer-readable medium storing computer-executable instructions that, when executed, cause at least one computing device to:
determine, based on transaction history information, that a group of accountholders is associated with a common interest;
determine that one or more entities provide offerings relevant to the common interest; and
automatically create at least one new rewards program associated with the one or more entities, the at least one new rewards program allowing the group of accountholders to earn rewards associated with the common interest.

8. The at least one non-transitory computer-readable medium of claim 7, having additional computer-executable instructions stored thereon that, when executed, further cause at least one computing device to:
determine, based on the transaction history information, that a second group of accountholders is associated with a second common interest different from the first common interest;
determine that a second set of one or more entities provide offerings relevant to the second common interest; and
automatically create a second new rewards program associated with the second set of one or more entities, the second new rewards program allowing the second group of accountholders to earn rewards associated with the second common interest.

9. The at least one non-transitory computer-readable medium of claim 7,
wherein determining that one or more entities provide offerings relevant to the common interest includes identifying a product or service advertised on a website, and
wherein automatically creating at least one new rewards program includes:
determining a proposed discount for the product or service based on a price of the product or service available via the website;
transmitting the proposed discount to a particular one of the entities providing the identified product or service; and
receiving an acceptance from the particular entity.

10. The at least one non-transitory computer-readable medium of claim 9, wherein determining a proposed discount includes:
estimating a profit margin realized by the particular entity providing the identified product or service;
estimating, based on the number of accountholders included in the group and the estimated profit margin, a total profit amount expected to be realized by the particular entity; and
transmitting the estimated profit margin and the estimated total profit amount to the particular entity providing the identified product or service.

11. The at least one non-transitory computer-readable medium of claim 7, having additional computer-executable instructions stored thereon that, when executed, further cause at least one computer to:
automatically enroll at least one of the accountholders in the at least one new rewards program.

12. The at least one non-transitory computer-readable medium of claim 7, wherein the at least one new rewards program is automatically created based on an offer received from a particular one of the entities.

13. A method, comprising:
determining, by a computing device, for a particular accountholder, based on transaction history information associated with the accountholder, that a first rewards program in which the accountholder is not currently enrolled is more advantageous to the accountholder than a second rewards program in which the customer is currently enrolled.

14. The method of claim 13, wherein the first rewards program is determined to be more advantageous to the accountholder than the second rewards program because the accountholder would receive rewards worth a greater monetary value if enrolled in the first rewards program instead of the second rewards program.

15. The method of claim 13, wherein the first rewards program is determined to be more advantageous to the accountholder than the second rewards program because the accountholder would receive more rewards matching the accountholder's interests if enrolled in the first rewards program instead of the second rewards program.

16. The method of claim 15, further comprising:
prior to determining that the first rewards program is more advantageous than the second rewards program, determining, by the computing device, the accountholder's interests based on the transaction history information.

17. The method of claim 16, wherein categories of transactions that the accountholder has completed at frequencies that exceed one or more corresponding thresholds are determined to be the accountholder's interests.

18. The method of claim 15, further comprising:
prior to determining that the first rewards program is more advantageous than the second rewards program, receiving, by the computing device, user input specifying the accountholder's interests.

19. At least one non-transitory computer-readable medium storing computer-executable instructions that, when executed, cause at least one computing device to:
determine, for a particular accountholder, based on transaction history information associated with the accountholder, that a first rewards program in which the accountholder is not currently enrolled is more advantageous to the accountholder than a second rewards program in which the customer is currently enrolled.

20. The at least one non-transitory computer-readable medium of claim 19, wherein the first rewards program is determined to be more advantageous to the accountholder than the second rewards program because the accountholder would receive rewards worth a greater monetary value if enrolled in the first rewards program instead of the second rewards program.

21. The at least one non-transitory computer-readable medium of claim 19, wherein the first rewards program is determined to be more advantageous to the accountholder than the second rewards program because the accountholder would receive more rewards matching the accountholder's interests if enrolled in the first rewards program instead of the second rewards program.

22. The at least one non-transitory computer-readable medium of claim 21, having additional computer-executable instructions stored thereon that, when executed, further cause at least one computer to:
prior to determining that the first rewards program is more advantageous than the second rewards program, determine the accountholder's interests based on the transaction history information.

23. The at least one non-transitory computer-readable medium of claim 22, wherein categories of transactions that the accountholder has completed at frequencies that exceed one or more corresponding thresholds are determined to be the accountholder's interests.

24. The at least one non-transitory computer-readable medium of claim 21, having additional computer-executable instructions stored thereon that, when executed, further cause at least one computer to:
prior to determining that the first rewards program is more advantageous than the second rewards program, receive user input specifying the accountholder's interests.
